(19) United States
(12) Patent Application Publication
(10) Pub. No.: US 2004/0195154 A1
(43) Pub. Date: Oct. 7, 2004

(54) Flotation machine

(76) Inventors: Heikki Oravainen, Helsinki (FI); Seppo Ronkainen, Kaunianen (FI); Risto Jappinen, Helsinki (FI); Raimo Airola, Espoo (FI); Jari Sormunen, Espoo (FI)

Correspondence Address: MORGAN & FINNEGAN, L.L.P., 345 PARK AVENUE, NEW YORK, NY, 10154, US

(21) Appl. No.: 10/486,185

(22) PCT Filed: Aug. 12, 2002
(86) PCT No.: PCT/FI02/00660

(30) Foreign Application Priority Data
Aug. 17, 2001 (FI) 20011658

(51) Int. Cl. B03D 1/16

(52) U.S. Cl. 209/169

(57) ABSTRACT

The invention relates to a flotation machine used for separating valuable ingredients, such as metal concentrates, from the rest of the material, which flotation machine comprises at least means for feeding slurry to be treated in the flotation cell into said flotation cell, means for agitating the slurry by a rotor which is to be rotated by a rotation device installed in the vertical direction of the flotation cell underneath the rotor, means for feeding air into the slurry, means for removing the material flotated in the flotation cell and means for removing material that is left non-flotated in the flotation cell. According to the invention the shaft (11, 28) of the rotor (10, 26) meant for agitating the slurry (3, 23) and for feeding air into the slurry (3, 23) and of the rotation device (12, 27) is sealed in the flotation cell (1, 21) by a mechanical sealing member (15).

The present invention relates to a flotation machine that is used for separating valuable ingredients contained in a slurry, such as metal concentrates, from the rest of the material. In particular, the invention relates to the position of the slurry rotation mechanism and sealing.

For example in the WO publication WO 01/43881, there is described a flotation machine comprising a flotation cell for the slurry to be treated, and a slurry agitating and air feeding mechanism. In the flotation cell, there are arranged apertures for feeding slurry through the side wall of the cell and for removing non-flotated material through the cell bottom. The concentrate created by means of foam in the flotation cell is removed from the cell through the top part that is at least partly open. The apparatus designed for agitating the slurry and for feeding air, comprising both the rotation device of the agitating mechanism and the mechanism for feeding air into the slurry, is installed above the flotation cell, so that an shaft, partly immersed in the slurry, leads from said apparatus to the flotation cell. The shaft is hollow for feeding air into the slurry. That head of the shaft that is immersed in the slurry is provided with a rotor that agitates the surrounding slurry, and simultaneously air is fed to the slurry through the air supply apertures arranged in the rotor in order to flotate said slurry and to keep it in suspension. Into the flotation cell there are also fed reagents that are attached to the surface of the valuable particles to be recovered. These reagents make the valuable particles hydrophobic and thus help them to be attached to the air bubbles. After being attached to the air bubbles, the valuable particles start to rise upwards, towards the essentially open top surface of the flotation cell, where they form a stabile foam bed. In the so-called inverted flotation, the valueless ingredients are made hydrophobic, in which case the valuable ingredients are left non-flotated in the process.

From the DE patent 735213 it is known a flotation machine, in which air to be required in flotation is fed or air is suctioned by the agitating mechanism itself into the flotation cell from the top side through a separate rising tube, while slurry to be floated is fed into the flotation cell from the bottom side. The rotating motor of the rotor in the flotation machine is installed so that the rotor is rotated by means of a shaft installed through the bottom of the flotation cell. Because in the DE patent 735213 air flows from the top side to the rotor, guiding plates are shaped in the rotor for directing air. The guiding plates make the rotor more complicated than the rotor in the abovementioned WO publication 01/43881. Further, the self-suctioning feeding system of air is not, as known, suitable for large flotation cells, where the agitating mechanism is on the bottom of the cell.

The DE patent 731305 describes a device, which is used to protect the inlet of the agitating shaft of a flotation cell in the bottom of the flotation cell against the corroding effect of slurry to be treated in the flotation cell. This protection device for the inlet is installed into a tight contact with the agitating shaft of the flotation cell so that the shaft has an opening towards an air dome positioned downwards. Further, the sealing sleeve of the inlet is connected to a pressure air pipe, and thus overpressure is possible to be achieved in the end of the sealing sleeve having contact with outdoors in order to avoid a liquid leakage. The air dome connected to the agitating shaft and the pressure air protection connected to the sealing sleeve makes, however, the structure of the flotation cell complicated and thus easily faulty operating. Further, particularly applying to a large flotation cell the great bubbles possibly discharging from the air dome cause disturbances in the flotation process.

As the size of flotation cells has grown, also the slurry agitating equipment has grown in size; both the size and efficiency of the rotation device have increased, and the length of the rotor rotation shaft has grown, because the height of the flotation cell has grown. Now higher tensile forces are directed to the rotor rotation mechanism, which in part intensifies the forces directed to the bearings installed in the rotation mechanism. Therefore, the known solutions for instance the protections for the inlet of the rotating shaft positioned in the bottom of a flotation machine are not any more workable.

The object of the invention is to alleviate the drawbacks of the prior art and to realize an advanced flotation machine, where the rotor rotation mechanism is installed, with respect to the rotor, underneath it, and the shaft of the rotor meant for agitating the slurry is connected to the rotor, to the bottom part thereof and the inlet of the rotor shaft is protected against mechanical wearing in an essentially simple way. The essential novel features of the invention are enlisted in the appended claims.

The flotation machine according to the invention comprises at least means for feeding the slurry to be treated in the flotation cell to the flotation cell, means for agitating the slurry, means for feeding air into the slurry, means for removing the material flotated in the flotation cell and means for removing the material that is left non-flotated in the flotation cell. The arrangement meant for agitating the slurry and for feeding air, constituting both the rotation device of the agitating mechanism and the mechanism for feeding air into the slurry, is installed underneath the rotor with respect to the vertical direction of the flotation cell. The shaft provided in between the rotor rotation mechanism and the rotor is attached to the rotor in an essentially vertical direction underneath the rotor. In addition, the shaft connected to the rotor is hollow inside, which makes it possible to feed in the air that is dispersed in the slurry. The shaft connected to the rotor can also be at least partly sealed, and the air is fed through a separate construction. Then a firmer rotor construction than before is achieved.

According to the invention in the sealing of the inlet positioned in the bottom of the flotation cell for the shaft between the rotor rotation device and the rotor itself it is used a sealing member, which advantageously without any special protection is resistive for the wearing influence of slurry to be treated in the flotation cell. It is possible, if needed, to feed in the sealing member pressurized liquid, as water, which after flowing through the sealing member is discharged into the flotation cell. Pressurized liquid can be circulated also only inside the sealing member without that liquid is discharged into the flotation cell. The sealing parts of the sealing member are made of material resistive for mechanical wearing, such as silicon carbide, tungsten carbide, metal oxides as alumina, carbon graphite, polymers or plastics as Teflon plastics. The sealing member is, if needed, also protected by an external system, which contains a mechanical protection and flushing liquid for the cleaning of the sealing member.

In the sealing of the inlet positioned in the bottom of the flotation cell for the shaft between the rotor rotation device and the rotor itself it is advantageously used a mechanical slip-ring sealing or for instance gland packing. In connection to the slip-ring sealing it can be installed a bellows member, which is possible to fill with water. This bellows can be used when needed to the prevention of wearing for the parts separated from the sealing faces of the slip-ring sealing. Liquid received from the bellows installed in connection with the slip-ring sealing is advantageously circulated so that liquid is not discharged into the flotation cell, but using liquid it is achieved an essentially sufficient flushing and cooling influence for the slip-ring sealing.

According to the invention, when the arrangement designed for agitating the slurry contained in the flotation cell and for feeding in air is installed underneath the rotor, vertically with respect to the flotation cell, the shaft between the rotor and the rotation device is made essentially short, because in order to achieve an efficient operation of the flotation cell, the rotor is placed essentially near to the bottom of the flotation cell. Owing to the short shaft, the efficiency required of the rotation device can also be reduced, in which case the rotation device can be made smaller in size, which as such is advantageous for sealing and for the structure of the whole flotation machine.

According to the invention, the arrangement designed for rotating the shaft and for feeding in air is installed underneath the rotor, so that the rotation device is located at least partly inside the flotation cell, or so that the rotation device is located completely outside the flotation cell. When the rotation device is at least partly inside the flotation cell, the rotation device is surrounded by a protective shell installed around it. In the wall of the protective shell, there is further made a lead-through for the shaft between the rotation device and the rotor, and when necessary, an additional lead-through for the elements connecting the rotation device in order to be able to receive rotation energy. If the rotation device is placed outside the flotation cell, the rotation device can, when necessary, likewise be provided with a protective shell. In case the rotation device is not protected by a shell, the bottom of the flotation cell is advantageously provided with a lead-through for the shaft between the rotation device and the rotor. Advantageously the shaft provided between the rotation device and the rotor is separate from the discharge aperture provided for the non-flotated material. However, the lead-through for the shaft between the rotation device and the rotor can also be common with the discharge aperture for the non-flotated material.

According to a preferred embodiment of the invention, the shaft between the rotation device and the rotor has inside a channel in order to be able to feed the rotor with air that is dispersed in the slurry. In the immediate vicinity of the rotation device, there are further installed means for feeding air from the conduit member designed for feeding air to the interior of the shaft between the rotation device and the rotor. Said air feeding means installed in the immediate vicinity of the rotation device are advantageously arranged in a protective shell possibly provided around the rotation device. Thus the protective shell also is provided with at least one lead-through for at least one conduit member designed for feeding air. Thus the shaft between the rotation device and the rotor is, for the part that falls between the rotor and the flotation cell bottom, immersed in the slurry flotated in the flotation cell. According to another preferred embodiment of the invention, the air dispersed in the slurry can also be conducted into the flotation cell as separate from the shaft between the rotation device and the rotor, advantageously for instance at the top part of the flotation cell, by means of a separate conduit member, directly onto the rotor. In that case the shaft provided between the rotation device and the rotor can be sealed, which as such improves the lasting wear of the shaft.

The invention is described in more detail below with reference the appended drawings, where

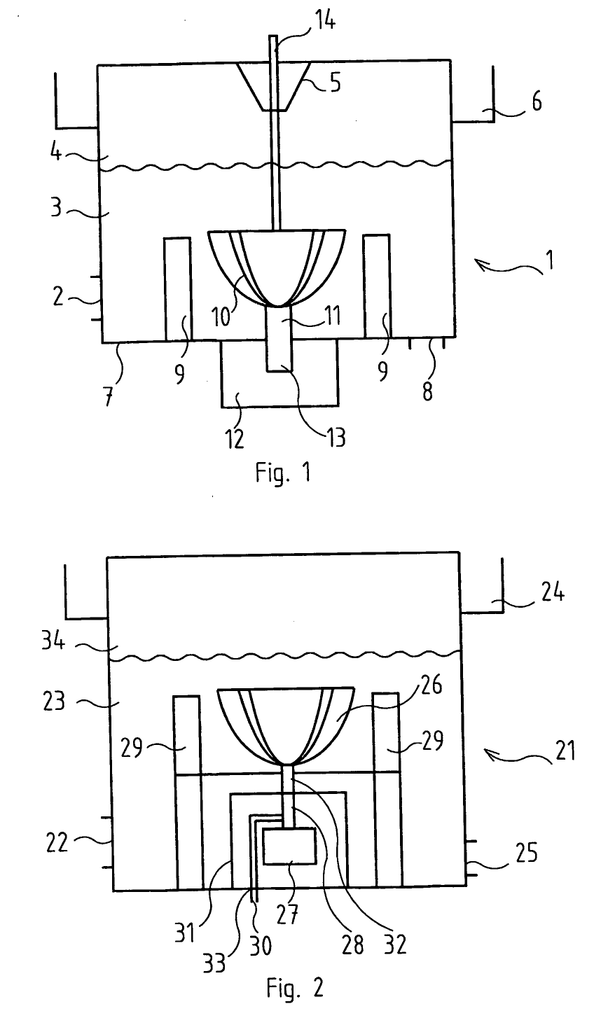

FIG. 1 shows a preferred embodiment of the invention, seen in a partly cross-sectional illustration, and

FIG. 2 shows another preferred embodiment of the invention, seen in a partly cross-sectional illustration,

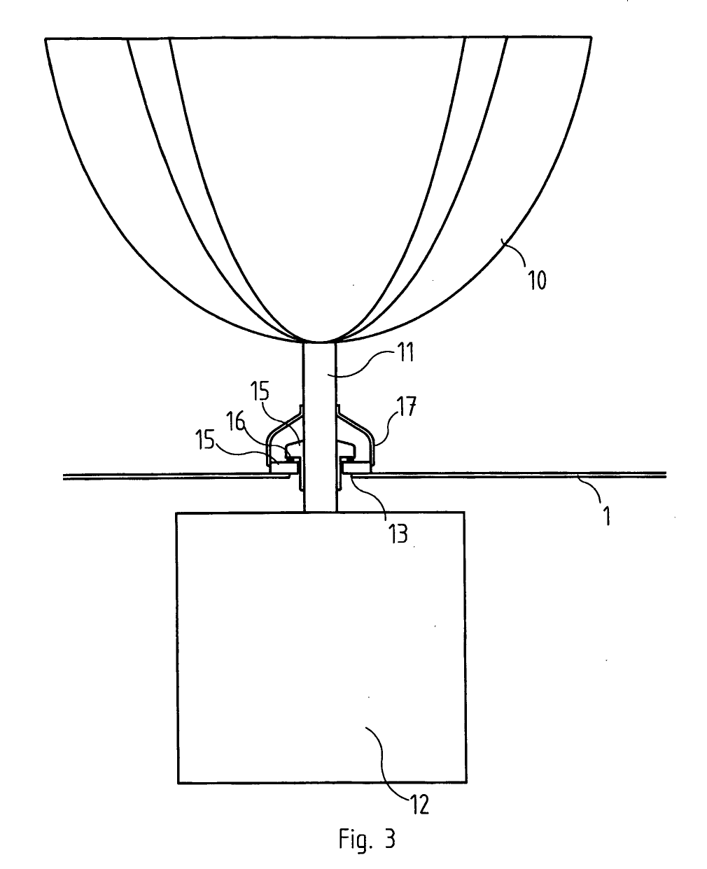

FIG. 3 shows the sealing between the rotor rotation device and the rotor in the flotation cell of the embodiment in FIG. 1, seen in a partly cross-sectional illustration.

According to FIG. 1, the flotation machine includes a flotation cell 1, and in the essentially vertical side wall of this flotation cell, there is made an aperture 2 in order to feed the slurry 3 to be treated in the flotation cell 1. In the top part of the flotation cell 1, there is installed an element 5 for aligning the foam bed 4 so that the foam bed 4 is made to proceed towards the foam discharge chute 6 installed around the flotation cell side wall. At the bottom 7 of the flotation cell 1, there is further formed an aperture 8 through which the material that is left non-flotated in the flotation cell 1 is removed therefrom. In addition, in the flotation cell 1 there is installed a stator 9 and coaxially and essentially on the same level with the stator 9, a rotor 10 designed for agitating the slurry and for dispersing air therein. The rotor 10 is rotated by means of an shaft 11 installed according to the invention, said shaft being attached to the rotor 10 in an essentially vertical direction underneath the rotor 10, with respect to the vertical direction of the flotation cell 1. In order to rotate the shaft 11, that end of the shaft 11 that is opposite to the rotor 10 is provided with a rotation motor 12. The rotation motor 12 is installed underneath the flotation cell 1, outside the flotation cell 1, near the bottom of the flotation cell 1. For the shaft 11 provided between the rotation motor 12 and the rotor 10, the bottom of the flotation cell is provided with an shaft aperture 13, through which the rotor 10 is rotated in order to agitate the slurry and to disperse air therein. In order to feed air to be dispersed in the slurry onto the rotor 10, to the rotor 10 there is connected a conduit member 14, through which the air coming from outside the flotation cell 1 is conducted to the rotor 10.

In the embodiment according to FIG. 2, the flotation machine comprises a flotation cell 21, and in the vertical wall of the flotation cell there is made an aperture 22 for feeding in the slurry-like material 23 to be flotated in the flotation cell 21. Around the top part of the flotation cell 21, there is installed a discharge chute 24 for removing flotated material that forms a foam bed 34 in the flotation cell 21. Moreover, in the wall of the flotation cell 21 there is made an aperture 25 for removing non-flotated material from the flotation cell 21. Further, the flotation cell 21 is provided with a rotor 26 that is installed to rest on its shaft 28 coming from the rotation motor 27. Coaxially with the rotor 26 and essentially on the same level around the rotor 26, there is installed a stator 29. The shaft 28 is attached to the rotor 26 in an essentially vertical direction underneath the rotor 26 with respect to the vertical direction of the flotation cell 21. In addition, the interior of the shaft 28 is hollow, and through the shaft 28, by means of the rotor 26, to the flotation cell 21 there is fed air to be dispersed in the slurry 23. The rotation motor 27 of the shaft 28 of the rotor 26 arranged in the flotation cell 21, as well as the means 30 provided for feeding air into the shaft 28 and located in the immediate vicinity of the rotation motor 27, are installed inside the flotation cell, above the bottom of the flotation cell 21. Around the rotation motor 27, there is further installed a protective shell 31, and in that wall of said shell that is located nearest to the rotor 26, there is made an shaft aperture 32 through which the shaft 28 arranged between the rotor 26 and the rotation motor 27 is made to rotate in order to rotate the rotor 26. In the wall of the protective shell 31, there also is made at least one aperture 33 for feeding air coming from a source outside the flotation cell 21 into the shaft 28 and for transferring the power that is required in the rotation motor 27 from outside the flotation cell 21 to the rotation motor 27. When the rotation motor 27 is placed inside the flotation cell 21, the shaft 28 arranged between the rotation motor and the rotor is advantageous made even shorter.

In FIG. 3 the shaft opening 13 positioned in the bottom of the flotation cell 1 for the shaft between the rotation motor 12 and the rotor 10 is sealed by a mechanical slip-ring sealing 15. The sealing face 16 of the slip-ring sealing 15 is made of a material resistive for wearing silicon carbide. In connection with the slip-ring sealing 15 it is installed a rubber bellows 17, which is possible to fill with water. This rubber bellows 17 can when needed be used for the prevention of wearing for the parts separated from the sealing faces of the slip-ring sealing 15. Water received from the bellows 17 installed in connection with the slip-ring sealing 15 is advantageously circulated so that water is not discharged into the flotation cell 1, but using water it is achieved an essentially sufficient flushing and cooling influence for the slip-ring sealing 15.

1. A flotation machine used for separating valuable ingredients from the rest of the material, which flotation machine comprises a feeding element for feeding slurry to be treated in the flotation cell into said flotation cell, an agitating element for agitating the slurry by a rotor which is to be rotated by a rotation device installed in the vertical direction of the flotation cell underneath the rotor, a shaft between the rotation device of the rotor and the rotor, a feeding element for feeding air into the slurry, a first removal element for removing the material flotated in the flotation cell and a second removal element for removing material that is left non-flotated in the flotation cell, the shaft of the rotor used for agitating the slurry and for feeding air into the slurry and of the rotation device being sealed in the flotation cell by a mechanical sealing member.

2. A flotation machine according to claim 1, wherein the mechanical sealing member is a slip-ring sealing.

3. A flotation machine according to claim 2, wherein the sealing face of the slip-ring sealing is made of material resistive for wearing.

4. A flotation machine according to claim 2, wherein the slip-ring sealing is provided with a bellows to be filled with liquid.

5. A flotation machine according to claim 1, wherein the mechanical sealing member is a gland packing.

6. A flotation machine according to claim 1 wherein the rotation device of the rotor used for agitating the slurry is placed at least partly inside the flotation cell.

7. A flotation machine according to claim 1, wherein the shaft provided between the rotation device of the rotor and the rotor used for agitating the slurry is attached to the rotor in an essentially vertical direction underneath the rotor.

8. A flotation machine according to claim 1, wherein the rotation device of the rotor used for agitating the slurry is installed in a protective shell provided with a lead-through for at least the shaft between the rotation device and the rotor.

9. A flotation machine according to claim 1, wherein in the flotation cell contains a conduit member that is separate with respect to the shaft of the rotor in order to feed air that is dispersed in the slurry onto the rotor.

10. A flotation machine according to claim 1, wherein the shaft of the rotor installed in the flotation cell has inside a channel in order to feed air that is dispersed in the slurry onto the rotor through the shaft.
